(19) United States
(12) Patent Application Publication
(10) Pub. No.: US 2009/0014966 A1
(43) Pub. Date: Jan. 15, 2009

(54) Folding Bellows Arrangement For A Tripod Joint Unit

(76) Inventors: Joachim Wette, Hennef (DE); Thorsten Scholtz, Rheinbreitbach (DE)

Correspondence Address: DICKINSON WRIGHT PLLC, 38525 WOODWARD AVENUE, SUITE 2000, BLOOMFIELD HILLS, MI, 48304-2970, US

(21) Appl. No.: 12/280,539

(22) PCT Filed: Dec. 28, 2006
(86) PCT No.: PCT/EP2006/012566

§ 371 Date: Aug. 22, 2008

(30) Foreign Application Priority Data
Feb. 22, 2006 (DE) 102006008558.2

(51) Int. Cl. F16J 15/52; F16J 15/02

(52) U.S. Cl. 277/634; 277/650

(57) ABSTRACT

In order to achieve the object of making available a folding bellows arrangement by means of which the acting clamping forces can be transmitted as uniformly as possible to the joint outer part of a tripod joint unit, it is proposed that such a folding bellows arrangement comprises a folding bellows (12) with a first collar region (20) for attachment to a shaft, and a second rotationally symmetrical collar region for attachment to a joint outer part (18) and a bellows region (16) which is arranged between the first and second collar regions, and an adapter ring (14) with an inner face which is adapted in a cross section to the outer contours of the joint outer part, the folding bellows being formed from an elastic material and the adapter ring being manufactured from at least one first plastic material (56) which has an approximately identical or higher Shore hardness than the material of the folding bellows.

The present invention concerns a folding bellows arrangement for a tripod joint unit, comprising a folding bellows and an adapter ring, and also concerns a suitable adapter ring.

Tripod joint units have joint outer parts whose outer circumference on the opening side has a trefoil shape in cross-section, in other words have three projections and three recesses with uniform angular spacing around the circumference corresponding to the tripod arrangement of trunnions and rollers of the joint inner part. The joint outer parts thus have lobular and flat regions and transition regions between the lobular and flat regions. Consequently, joint outer parts designed in this way do not provide the prerequisites for direct mounting of rotationally symmetric folding bellows, because the folding bellows, which are typically produced by blow-molding from tube sections, can only be made essentially rotationally symmetric, where even the forming of thickened areas for the collar region requires special measures.

For this reason, it is customary to use folding bellows arrangements which include an adapter ring and a folding bellows, wherein the adapter ring and the folding bellows can also be joined to one another as a single piece. Here, the appropriately shaped inner surface of the adapter ring can be mounted on the trefoil outer surface of a joint outer part.

DE 10 123,216 A1 discloses such a folding bellows arrangement in which the adapter ring is joined to the bellows section by thermal sealing or gluing. The adapter ring here is designed with radially thickened regions uniformly distributed over the circumference in order to provide appropriate seating on the lobular regions of the joint outer part. Due to this accumulation of material in the corresponding thickened regions, uniform inward radial compression distributed over the circumference is not possible in fastening the folding bellows arrangement onto the joint outer part by means of a binder, which is customarily designed as a collar band or other clamping means. T his can result in uneven sealing between the adapter ring and the joint outer part, so that contaminants can penetrate to the interior of the tripod joint unit.

EP 0,915,264 A2 discloses another folding bellows arrangement produced by a blow-molding method, wherein the folding bellows is joined to an adapter ring as a single piece. Viewed in cross-section, the adapter ring here has an inner wall section matched to a joint outer part and a cylindrical outer wall section. Provided between the inner wall sections and the cylindrical outer wall section are resilient radial ribs whose thickness corresponds approximately to the thickness of the wall sections. However, high radial compression for achieving adequate sealing between the adapter ring and the joint outer part in such a design of the adapter ring is limited by the elasticity of said ribs.

U.S. Pat. No. 6,672,596 B2 discloses a folding bellows arrangement incorporating a folding bellows and an adapter means, wherein these are designed as two parts and wherein reinforcing elements, preferably of metal, are placed in the wall sections of the adapter means. This measure is intended to achieve more uniform inward-directed compression when this folding bellows arrangement is fastened onto a joint outer part by means of a binder. Here too, however, the nonuniform arrangement of such reinforcing elements over the entire cross-sectional area of the adapter ring results in only an uneven sealing over the entire circumferential surface between the adapter ring and the joint outer part.

Lastly, WO 2005/010,387 A1 discloses a folding bellows arrangement incorporating a folding bellows and an adapter ring, wherein the folding bellows is made of a plastic material that is harder than the material of the adapter ring. Such materials are typically used in accordance with prior art as well. A special design of the geometry of the inner circumference of the adapter ring is intended to provide adequate sealing with the folding bellows arrangement disclosed there.

The object of the present invention is to provide a folding bellows arrangement that is simple to manufacture and that also provides uniform sealing over the entire region between the inner circumferential surface of the adapter ring and the outer circumferential surface of a joint outer part that has a trilobular design.

This object is attained through an inventive folding bellows arrangement for a tripod joint unit, comprised of a folding bellows with a first collar region for attachment to a shaft, a second rotationally symmetric collar region for attachment to a joint outer part and a bellows region arranged between the first and second collar regions, and an adapter ring with an inner surface that is matched in cross-section to the outer contour of the joint outer part, wherein the folding bellows is made of an elastic material, characterized in that the adapter ring consists of at least one first and one second plastic material, wherein the first plastic material has a Shore hardness pursuant to ISO 868 that is approximately equal to or higher than that of the material of the folding bellows.

The inventive folding bellows arrangement has the advantage that due to the at least approximately equal or greater hardness of the plastic material used for the adapter ring, and its preferably different material properties as compared to the material of the folding bellows, the radial clamping forces produced by a binder, for example a clamping ring, are transmitted directly to the inner surface of the adapter ring without resulting in flowing of the material in the adapter ring. The adapter ring here is advantageously made of at least the first and a second plastic material. With such an at least two-component design of the adapter ring, it is possible to optimize the design thereof as a function of application conditions. Such at least two-component, more preferably exactly two-component, adapter rings can be produced by multi-component injection molding, for example. However, other production methods are also possible, for example injection blow-molding. In this regard, the adapter ring can be advantageously joined with the bellows as a single piece, wherein this is achieved by their production together through injection blow-molding, for example, or else by later gluing of the adapter ring into the folding bellows, for example. However, every other way of joining the adapter ring to the folding bellows is also made possible, including in particular the options disclosed in DE 10 123,216 A1 of interlocking engagement or frictional engagement of the two parts.

In advantageous fashion, the side of the adapter ring facing away from the joint outer part is made at least partly, preferably completely, of the first plastic material, which has a higher Shore hardness than the second plastic material. In particular, the first plastic material here can be chemically similar, preferably also chemically identical to, the material of the folding bellows, in order to avoid incompatibilities of the immediately adjacent materials. The clamping forces are then first transmitted by the softer material of the collar region of the folding bellows to the harder, first plastic material of the adapter ring, and then to the second, softer plastic material of the adapter ring. The inventors of the present invention have recognized that, contrary to the preconception in the prior art, for a uniform transmission of the clamping forces with simultaneously good sealing in folding bellows arrangements for joints with trilobular design, it is not the material of the adapter ring adjacent to the outer circumferential surface of the trilobular joint outer part that needs to have a higher Shore hardness than the material of the collar region of the folding bellows, or the material of the entire folding bellows. This is because an extremely uniform transmission of the clamping forces to the outer circumferential surface of the joint outer part, without losses due to distance, takes place precisely because of the provision of a material with a higher Shore hardness, specifically in the flat regions, in the lobular regions, and in the transition regions located therebetween, which taken together constitute the outer contour of the joint outer part. In order to permit even greater optimization here, it is advantageously possible for the wall thickness of the adapter ring to be made in a two-component manner of two plastic materials, wherein at least approximately 10%, preferably at least approximately 30%, and even more preferably at least approximately 50% of the wall thickness of the adapter ring is made of the first plastic material, and hence of a plastic material having a higher Shore hardness. It is further preferred here for the second plastic material to be arranged over the entire surface on the inside of the adapter ring, preferably with a wall thickness of at least 1%, preferably with a wall thickness in a range from approximately 1% to approximately 40%, even more preferably with a wall thickness in a range from approximately 2% to approximately 30%, so that it is in direct contact with the outer circumferential surface of the joint outer part. The material thickness of the first and second plastic material can vary over the cross-sectional area as a whole, in particular in the lobular regions of the joint outer part as compared to the adjacent transition or flat regions, with the thinnest material thickness preferably being provided for the second plastic material in the transition regions. However, with a view to the simplest possible manufacture of the inventive folding bellows arrangement, it is also possible to arrange a uniformly thick layer of the second plastic material having a lower Shore hardness on the inside of the adapter ring. Within the context of the present invention, the Shore hardness is determined pursuant to ISO 868, with Shore A hardness or Shore D hardness being determined depending on the plastic material used. Shore A hardness and Shore D hardness can be placed in relationship to one another through comparison tables.

In advantageous fashion, the Shore hardness, especially Shore A hardness, of the second plastic material is at least 10%, more preferably at least 20%, even more preferably at least 25% lower than the Shore A hardness of the first plastic material. It is also preferred here for the Shore hardness of the second plastic material to be approximately equal to the Shore hardness of the plastic material used to produce the collar region of the folding bellows. It is also preferred for the Shore A hardness or Shore D hardness of the first plastic material to be at least approximately 10% higher than the Shore A (D) hardness of the folding bellows material, more preferred at least approximately 20%, and even more preferred at least approximately 25%. The Shore D hardness of the first plastic material here is preferably at least approximately 40, even more preferably at least approximately 50, and even more preferably at least approximately 55.

In a preferred embodiment of the inventive folding bellows arrangement, the adapter ring has, arranged on its inner surface facing the joint outer part, at least one, preferably exactly two, sealing lips, which preferably are made of the second plastic material. The sealing lips here can be arranged on the inner circumferential surface of the adapter ring to be continuous, but can also be discontinuous. The inventors have recognized that an even more extremely uniform transmission of the clamping forces occurs if only the at least one sealing lip is made of the softer, second plastic material, but the adapter ring otherwise is made of the first, harder plastic material. Naturally, however, provision can also be made for the inner side of the adapter ring facing the joint part to also be provided on its full area, which is to say in addition to the sealing lips, with the second plastic material, if applicable also in different material thicknesses.

Advantageously, the first plastic material is selected from a group comprised of polypropylenes, polyethylenes, polyacetal resins (POM), polyamides (PA), linear polyesters (especially polybutylene terephthalate (PBT)), and/or thermoplastic elastomer ether-esters (TEEE). In this connection, the first plastic material can also be composed of copolymers, block polymers, or random block copolymers of the aforementioned plastic materials. The material of the folding bellows is advantageously composed of a thermoplastic elastomer material (PTE), and in particular of a thermoplastic elastomer ether-ester (TEEE), and hence of a material which can be identical to the first plastic material. However, the first plastic material preferably has a higher Shore hardness than the plastic material of the folding bellows.

The second plastic material is advantageously composed of a group comprised of thermoplastic olefins, polychloroprenes, and/or thermoplastic elastomers (TPE), especially also thermoplastic vulcanized rubbers (TPV), but also TEEE of lower hardness.

The first thermoplastic material also has, in contrast to the second plastic material, higher values for tensile strength, elongation at break, and tensile modulus, each measured in accordance with the ISO 527 standard. Preferably, the tensile strength of the first plastic material is at least approximately 10%, preferably at least approximately 20%, above that of the folding bellows material and of the second plastic material. Preferably, the tensile strength of the first plastic material is at least approximately 16 MPa, more preferably at least approximately 18 MPa.

The elongation at break of the first plastic material is preferably at least approximately 150% (1 mm/minute), more preferably at least 170% (1 mm/minute). The tensile modulus of the first plastic material is preferably at least approximately 45 MPa, more preferably at least approximately 50 MPa, even more preferably at least 60 MPa, and is preferably in a range from approximately 45 to approximately 140 MPa, more preferably in a range from approximately 60 MPa to approximately 125 MPa. In contrast, the tensile modulus of the second plastic material is less than 45 MPa. Preferably, the first and/or second plastic material of the adapter ring has no anchoring agent. The melting point of the first plastic material is preferably at least 180° C., more preferably at least 200° C.

The present invention additionally concerns an adapter ring as defined above, for use in tripod joint units, in particular an adapter ring whose at least one sealing lip is made of the second plastic material, if applicable in further combination with an inner surface made at least partly of the second plastic material, which inner surface directly contacts the outer circumferential surface of the joint outer part, wherein different material thicknesses of the second plastic material may also be present in the adapter ring wall here as well, and otherwise consists of the first plastic material and is the same hardness or harder than the folding bellows material.

These and other advantages of the present invention are explained in detail on the basis of the attached figures. Shown are:

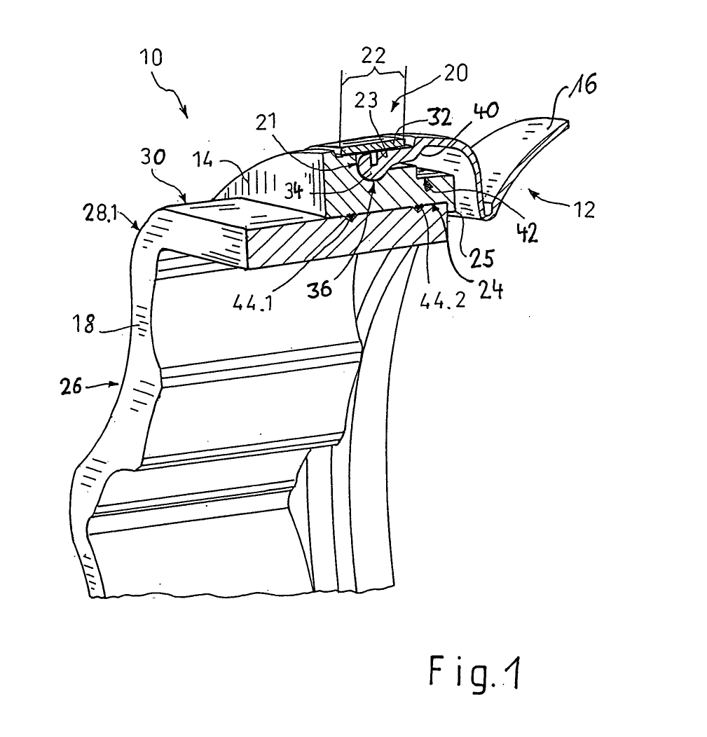

FIG. 1: a perspective sectional view of an inventive folding bellows arrangement located on a joint outer part;

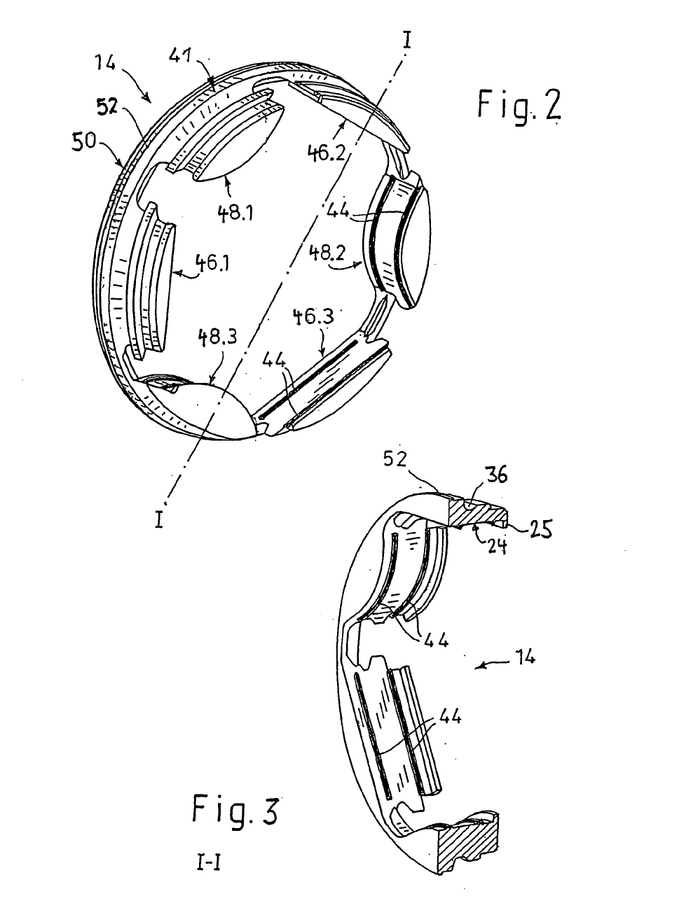

FIG. 2: an adapter ring from FIG. 1 in a perspective view;

FIG. 3: the adapter ring from FIG. 2 in a sectional view;

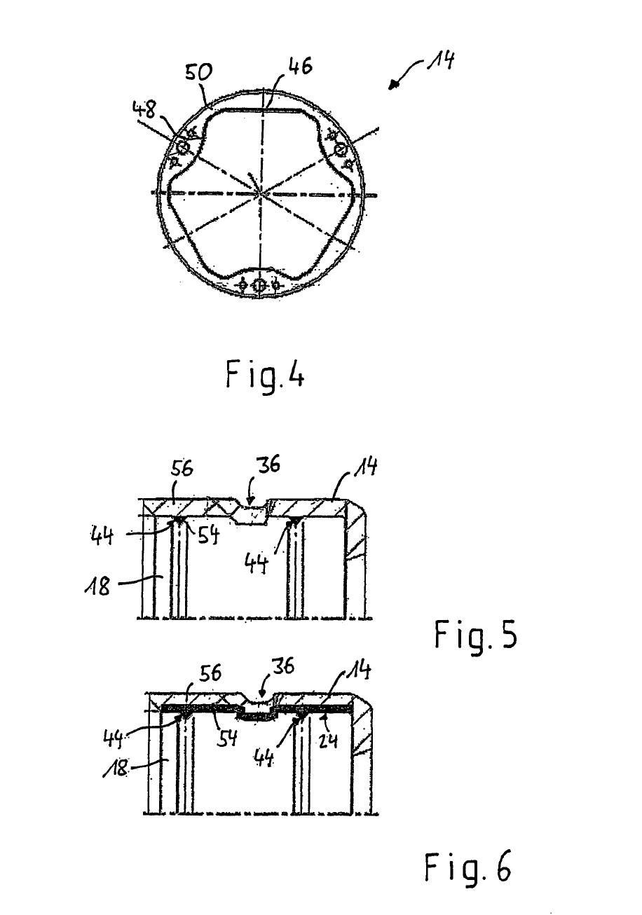

FIG. 4: another embodiment of an adapter ring;

FIG. 5: an adapter ring from FIG. 4 with sealing lips made of a first plastic material;

FIG. 6: the adapter ring from FIG. 4 with sealing lips and full-area inner surface made of the first plastic material.

It is first necessary to mention that the features shown in the drawings are not restricted to the individual embodiment. Rather, the features disclosed in each case in the description, including the drawing description and the drawings, can be combined with one another further. Like features here are labeled with like reference numbers. In particular, the object of the present invention is not limited to the embodiments of the adapter ring shown in the figures. Rather, any additional possible embodiments of adapter rings may be used here, in particular also including such with specific designs of the regions with accumulations of material which engage the lobular regions of the joint outer part, such as are disclosed in EP 0,915,264 A2 or WO 2005/010,387 A1, for example.

FIG. 1 shows an inventive folding bellows arrangement labeled overall with reference number 10, consisting of a folding bellows 12 with a bellows region 16 and a collar region 22, an adapter ring 14, and a binder 32, which is designed as a tension band, for example. Not shown in FIG. 1 is the first collar region of the folding bellows 12, which is used for attachment to a shaft that likewise is not shown here. To this end, reference is made to the disclosure of DE 10 123,216 A1, for example.

The joint outer part 18 has three lobular regions 26, of which only one is shown, and correspondingly has three flat regions 30 with a transition region 28.1 being arranged between the lobular region 26 and the flat region 30. The trilobular joint outer part has a total of six transition regions 28.1 through 28.6 (not shown here). The inner surface 24 of the adapter ring 14, seen in cross-section, is matched to the outer contour of the joint outer part defined by said regions.

The collar region 20 has a binder seat 22 with a binder seat surface 23, in which engages a binder 32, designed, for example, as a tension band. The collar region 20 also includes an annular ridge 34, which engages in a recess 36 of the adapter ring 14 and rests its joint-side edge 21 against a suitably designed wall of the receptacle 36 of the adapter ring 14.

The folding bellows arrangement 10 from FIG. 1 also has a shoulder 40 in the folding bellows 12 and a shoulder 42 in the adapter ring 14, thereby permitting the greatest possible mobility for the folding bellows 12. The adapter ring 14 also has a projection 25, which extends around the edge of the joint outer part 18 so as to permit secure seating. In addition, the adapter ring 14 has two sealing lips 44.1 and 44.2, which are approximately triangular in design when viewed in cross-section, but can also have any other design, for example half-round or other designs. These sealing lips 44.1 and 44.2 are made of a second plastic material having a lower Shore A hardness, for example a Shore A hardness of approximately 60 to approximately 80, corresponding to a Shore D hardness of approximately 25 to approximately 35, which is indicated in FIG. 1 by shading. In contrast, the remaining plastic material of the adapter ring 14 has a higher Shore A hardness, which can also be the case for the plastic material used for the folding bellows 12. Otherwise, the adapter ring is made of a hard, first plastic material with a Shore D hardness of approximately 50, for example.

FIG. 2 now shows the adapter ring from FIG. 1 in a perspective view, where it is clearly visible that the adapter means 14 has an outer circumferential surface 41 and an adjusting means 52, which is designed as an annular ridge and is used for adjusting the binder 32 from FIG. 1. The adapter means 14 has a total of three flat contact surfaces 46.1, 46.2, and 46.3, and three lobular contact surfaces 48.1, 48.2, and 48.3, by means of which the adapter means 14 rests against the joint outer part 18, which is not shown here. Located between these regions of the adapter ring 14, which are complementary to the flat and lobular regions of the joint outer part, are a total of six transition regions 50, of which only one is shown here. Moreover, it is clearly evident from FIG. 2 that the contact surfaces 46.1 to 46.3 and 48.1 to 48.3 have sealing lips 44 that are arranged in a discontinuous manner on the adapter ring 14 and are made of the second plastic material, which has a hardness that is not only lower than the other plastic material provided in the adapter ring 14, but also preferably has a lower Shore hardness than the plastic material of the folding bellows 12, not shown here.

FIG. 3 shows a sectional view of the adapter means from FIG. 2 along section line I-I, with the arrangement of the sealing lips 44 on the lobular and flat regions of the contact surfaces of the adapter means 14 being especially clearly visible here. As a whole, the folding bellows arrangement 10 shown in FIG. 1 through FIG. 3 is one in which the binder seat surface 23 is formed partly by the adapter means 14 and partly by the collar region 20 of the folding bellows 12. Such a division of the binding seat 22 makes it possible to provide a system in which a smaller cross-section of said seat can be achieved when in the closed state, in the area of the collar region 20 on the joint outer part side of the folding bellows 12. As a result of the division of the binder seat surface 23 between the adapter ring 14 and the collar region 20 of the folding bellows 12, it is possible to undertake material reductions in the transition regions 28 of the joint outer part located at its circumferential surface between the flat and lobular regions 30 and 26, thus reducing the overall height of the folding bellows arrangement 10.

Now, FIG. 4 shows an alternative embodiment of an adapter means 14, which does not have a division of the binder seat area 23 as described above. The adapter ring 14 also has flat contact surfaces 46 and lobular contact surfaces 48, with transition regions 50 being arranged between the flat 46 and lobular 48 contact surfaces. In the lobular regions, the adapter ring 14 has some circular recesses as shown in FIG. 4.

Now, FIG. 5 shows a two-component embodiment of the adapter ring 14 from FIG. 4, mounted on a joint housing outer part 18. The two sealing lips 44 here are made of the second plastic material 44, such as a polychloroprene (neoprene) for example, whereas in contrast the material of the adapter ring 14 is otherwise made of a first plastic material 56, which has a higher Shore hardness than the second plastic material 54, and is otherwise made of a different plastic material, such as a polyamide, for example.

In an alternative embodiment, FIG. 6 shows that the adapter ring 14 has the second plastic material 54 over its entire inner surface 24 facing the joint outer part, which material also forms the sealing lips 44. The second plastic material 54 makes up approximately 30% of the overall wall thickness of the adapter ring 14 in this design.

As illustrated by FIGS. 5 and 6, a folding bellows 12 can engage in the recess 36 by means of its collar region 20 and an annular ridge 34 arranged thereupon, wherein, in contrast to the embodiment shown in FIGS. 1 through 3, the collar region 20 of the suitably designed folding bellows 12 then makes available the entire binder seat surface 23.

The present invention advantageously makes it possible to provide a folding bellows arrangement with an adapter ring relatively economically, without the expensive use of, for example, metal reinforcement elements or the like, which bellows arrangement very uniformly transmits the clamping forces acting in fastening means, in particular clamping or tension elements including compression rings and tension bands, and thus provides a secure seat and seal on the joint outer part of the folding bellows arrangement.

1. A folding bellows arrangement for a tripod joint unit, comprising:
a folding bellows including a first collar region for attachment to a shaft, a second rotationally symmetric collar region for attachment to a joint outer part and a bellows region arranged between said first and said second collar regions;
and an adapter ring including an inner surface that is matched in cross-section to an outer contour of said joint outer part; wherein said folding bellows is made of an elastic material; wherein said adapter ring consists of at least one first and one second plastic material,
wherein said first plastic material has a Shore hardness pursuant to ISO 868 that is approximately equal to or higher than that of a folding bellows material of said folding bellows.

2. A folding bellows arrangement as described in claim 1, wherein a side of said adapter ring facing away from said joint outer part is made at least partly of said first plastic material, which has a higher Shore hardness than said second plastic material.

3. A folding bellows arrangement according to claim 1, wherein the Shore A hardness of said second plastic material is at least 10% lower than the Shore A hardness of said first plastic material.

4. A folding bellows arrangement according to claim 1, wherein at least approximately 10% of the wall thickness of said adapter ring is made of the said first plastic material.

5. A folding bellows arrangement according to claim 1, wherein said inner surface of said adapter ring is made entirely of the said second plastic material.

6. A folding bellows arrangement according to claim 1, wherein said adapter ring has, arranged on said inner surface, at least one sealing lip, which is made of said second plastic material.

7. A folding bellows arrangement according to claim 1, wherein the Shore A hardness of said first plastic material is approximately 10% higher than the Shore A hardness of the folding bellows material.

8. A folding bellows arrangement according to claim 1, wherein said folding bellows and said adapter ring are designed as a single piece.

9. A folding bellows arrangement according to claim 1, wherein said first plastic material is selected from a group comprised of polypropylenes, polyethylenes, polyacetal resins, polyamides, linear polyesters, and/or thermoplastic elastomer ether-esters.

10. A folding bellows arrangement according to claim 1, wherein said folding bellows is made of a thermoplastic elastomer material.

11. A folding bellows arrangement according to claim 1, wherein said second plastic material of said adapter ring is selected from a group comprised of thermoplastic olefins, polychloroprenes, and/or thermoplastic elastomers.

12. A folding bellows arrangement according to claim 1, wherein the tensile strength in accordance with ISO 527 of said first plastic material is at least approximately 10% above that of said folding bellows material.

13. A folding bellows arrangement according to claim 1, wherein the tensile strength of said first plastic material is at least approximately 16 MPa.

14. A folding bellows arrangement according to claim 1, wherein the Shore D hardness of said first plastic material is at least approximately 40.

15. A folding bellows arrangement according to claim 1, wherein said adapter ring composed of at least said first and said second plastic materials and is produced by multi-component injection molding.

16. An adapter ring for use in affixing a folding bellows to an outer joint part, the folding bellows made up of a folding bellows material, the adapter ring comprising:
an inner surface configured to engage the outer joint part;
a first plastic material; and
a second plastic material, said first plastic material having a Shore hardness pursuant to ISO 868 that is higher than the Shore hardness of said second material;
wherein a side of said adapter ring configured to face away from the outer joint part is made at least partly of said first material.

17. An adapter ring as described in claim 16, wherein the Shore A hardness of said second plastic material is at least 10% lower than the Shore A hardness of said first plastic material.

18. An adapter ring as described in claim 16, wherein at least 10% of the wall thickness of said adapter ring is comprised of said first plastic material.

19. An adapter ring as described in claim 16, wherein said inner surface is comprised entirely of said second plastic material.

20. An adapter ring as described in claim 16, wherein the tensile strength of said first plastic material is approximately 16 MPa.

21. An adapter ring as described in claim 16, wherein the Shore D hardness of said first plastic material is at least approximately 40.
